(19) United States
(12) Patent Application Publication
(10) Pub. No.: US 2007/0237347 A1
(43) Pub. Date: Oct. 11, 2007

(54) Hearing device

(75) Inventor: Manfred Pfeiler, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GMBH

(21) Appl. No.: 11/784,274

(22) Filed: Apr. 6, 2007

(30) Foreign Application Priority Data
Apr. 7, 2006 (DE) 10 2006 016 440.7

(51) Int. Cl. H04R 25/00

(52) U.S. Cl. 381/320; 381/328; 381/316

(57) ABSTRACT

A hearing device utilizes the effect of forming combination tones from two different tones within the ear based on non-linear transmission characteristics of the ear. The sound signals picked up and converted into electrical signals by the microphone are transposed by a carrier frequency into a frequency range above the audible range and fed to the ear together with the carrier frequency oscillation after a conversion by a sound emitter into acoustic signals, in which through the effect of the difference tone formation the transposition is reversed again, and thus the suitably processed sound signal is once more available in the audible frequency range.

### CROSS REFERENCE TO RELATED APPLICATIONS

This application claims priority of German application No. 10 2006 016 440.7 filed Apr. 07, 2006, which is incorporated by reference herein in its entirety.

Hearing devices are increasingly becoming accepted nowadays, as has long been the case with vision aids, i.e. spectacles. Hearing devices are however often more necessary for hard-of-hearing than spectacles are for the visually impaired, to do a job to one's full capabilities of to be able to participate in social life.

Microelectronics and data processing have allowed hearing devices to achieve a high level of development as far as picking up sound signals, processing them and passing them on to the ear of the hearing-impaired person is concerned. As a result of their miniaturization as behind-the-ear (BTE) or in the ear (ITE) devices the hearing devices are able to be worn inconspicuously, plays a part in giving the impression of self-confidence in the person wearing the hearing device.

Hearing devices are sound amplifiers, in which a microphone converts acoustic signals into electrical signals, in the simplest case amplifies these signals and feeds the amplified electrical signals to an electro-acoustic converter, which converts the electrical signals into acoustic signals. The electrical signals can however by subjected to signal processing before their conversion back into acoustic signals, with which an attempt is made to compensate for specific hearing problems, e.g. by increasing signal components in frequency ranges in which the hearing has become impaired.

The in-the-ear devices consist as a rule of a housing, in which all components such as microphone, amplifier, signal processing and an electro-acoustic converter (earpiece) are accommodated. Behind-the-ear devices are constructed of two parts, namely the housing to be worn behind the ear and the hearing module located in the ear. This unit is supplied with the sound signals either via the air or gas column located in a hose connection or by means of an electrical line, with the electro-acoustic converter or earpiece then being located in the hearing module.

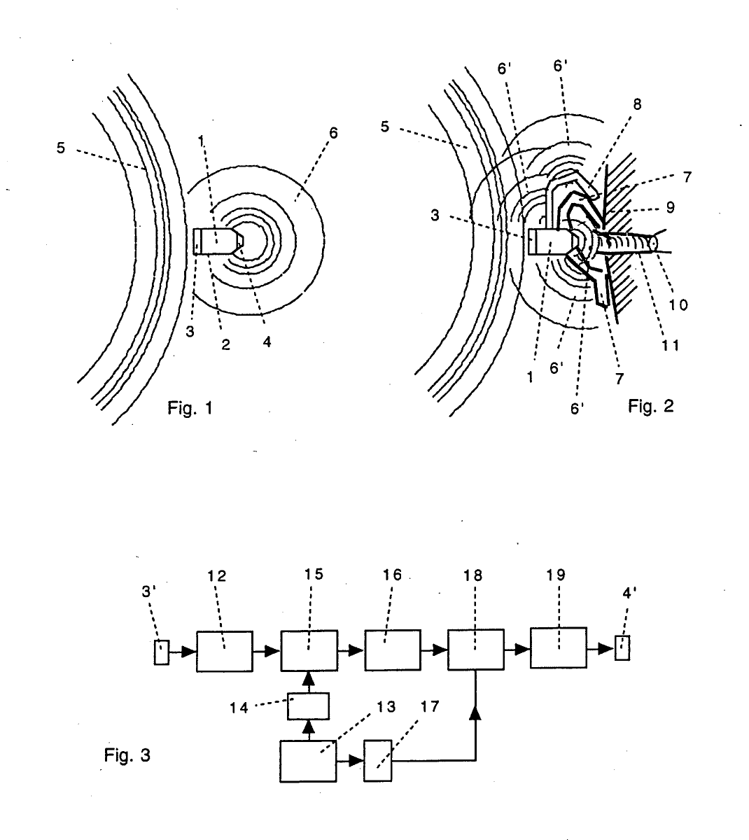

FIG. 1 shows the simplified diagram of an ITE device 1, with the microphone being located within the housing 2 at position 3 and the electro-acoustic converter, which converts the amplified and processed electrical signals into acoustic signals, at position 4, and which is also referred to below as the earpiece or sound emitter, and which in the case of a BTE device is located in the hearing module. The acoustic wave train meets the microphone at position 3, the earpiece at position 4 emits the acoustic wave train 6.

Wearers of modern hearing devices frequently complain about the problems involved in putting on the hearing device, both with the BTE devices, in which only the hearing module is to be inserted into the (outer) auditory canal, and also with ITE devices, in which the entire system is placed in the auditory canal. The complaint from wearers is of an initial unpleasant feeling of pressure. One effect which is felt to be particularly unpleasant however is the development of moisture caused by sweat in the auditory canal, above all over the contact surface between the housing of the hearing device and the skin of the auditory canal, whereby this wetness can lead both to skin irritations and can also adversely affect the function of the hearing device.

These unpleasant side-effects are rarely discussed since with the devices described they cannot be avoided and therefore must be accepted. The contact between the wall of the auditory canal and/or also the wall of parts of the ear muscle on one side and the tight-fitting molded housing of the hearing device or of its earpiece module on the other hand serves to produce the necessary sound sealing for acoustic decoupling of microphone and hearing module, and thereby to avoid feedback. Secondly the guidance of sound waves in the auditory canal from the earpiece in the hearing device or its hearing module to the eardrum allows a low acoustic sound output (and thereby lower power consumption of the device) which supports the acoustic decoupling mentioned.

Despite this feedback effects are observed rather frequently, if for example the hearing device is not inserted to form a tight fit in the ear or is shaken while being worn, or if over a longer period the shape of the hearing device or also of the auditory canal have changed and a close fit is no longer being produced. Since feedback effects are as a rule perceived as a loud whistling sound, they are extremely unpleasant both for the hearing device wearer but also for other people in their vicinity.

The hearing device will once again be compared to a vision aid as regards its character. Spectacles are frequently exclusively used if required. A long-sighted person will only wear spectacles for reading as a rule to see things in his field of vision that he would otherwise not see in sharp focus without spectacles, but the recognition of details is important for observing the complete focus.

Even if reading glasses have been put on, a large part of the field of vision can be perceived in a natural manner, if, with spectacles with narrow lenses it is possible to look comfortably over the top of the spectacles; it is thus not affected by the spectacles. Putting on or taking off a visual aid is possible with a single rapid hand action, making it a simple and convenient process.

For one of the BTE and ITE devices described above the situation produced in the intended comparison is different. Inserting a hearing device into the ear as required is simply more difficult than putting on spectacles. However there is also another basic difference. Whereas with spectacles a part of the field of vision can if necessary be looked at through the visual aid, but another part does not have to be, a comparable signal selection with a hearing device is not possible. Here the entire sound field is guided to the eardrum via the hearing device, even if specific frequency ranges of the sound field signals do not require amplification at all. For such frequencies, although no amplification is undertaken in the amplification system of the hearing device in relation to the perception of these signals without hearing device, the signals of these frequencies too are not perceived in a natural way. This is because these signals too undergo “processing” in the hearing device, even if the device is configured so that the signals are to remain as unchanged as possible. This is also expressed by the experience that with a hearing device the hearing is to be basically and completely removed. This is also true of the case in which the decision would be made to wear a hearing device even with small hearing defects.

Thus it is entirely a major psycho-physiological question as to whether a person with hearing difficulties in specific frequency ranges, but who can still follow conversations without difficulty, can put up with wearing a hearing device in order to ensure that their hearing again has access to the frequency range of the hearing of a younger person, since they are involved with music for example. Such a problem would not arise if the support for the hearing by a hearing device were comparable with the support for the eyesight described above, if therefore the signal range for example for which there are no hearing difficulties did not also have to be detected via the hearing device, and/or the hearing device could be easily taken off, i.e. did not have to be introduced completely or partly into the auditory canal.

A hearing device comparable to an extent to reading glasses in one especially important point would thus be one allowing the signal components with those frequencies in which the hearing does not exhibit any weaknesses direct access to the eardrum, but capturing the signal components of the other frequencies from the sound field, changing their amplitude, which generally means amplification, and adding them to the sound field. Necessarily connected to this characteristic so to speak would be the requirement for the hearing device or its hearing module to be able not to have to be introduced so as to form a close fit into the auditory canal.

Prior-art hearing devices do not have such characteristics. This is certainly also the reason why many people with increasing hearing difficulties decide (against the reasoned advice of hearing device specialists) only to start using a hearing device when doing so becomes indispensable for conducting a normal conversation.

The question which arises during such deliberations is to what extent, if at all, this close connection of hearing device or hearing module with the auditory canal is necessary. Could it not be sufficient, to avoid the feedback and the associated ambient problems already mentioned, in accordance with FIG. 2 to place the hearing device 1 or the hearing module associated with it by means of a holder 8 laid over the auditory muscle 7 as close as possible to the entry but still in front of the entry of the outer auditory canal 11, passing through the cranial bone 9 and ending at the eardrum 10?

The sound emitter or earpiece located in the hearing device 1 in the hearing module at position 4 is naturally small and has for example an effective emitter surface with a lengthwise extent of around one cm. The emitted sound waves are however of a comparatively longer wavelength; an acoustic oscillation of frequency 100 Hz at a speed of sound in air of around 330 m/s has a wavelength of around 3.30 m, and at 1000 Hz of around 0.33 m.

According to the laws of oscillation the sound emitter or earpiece of a hearing device, because of its comparatively small dimensions would be viewed in a first approximation as a point emitter, which in accordance with FIG. 1 thus emits evenly in all directions, which is indicated by the wave train 6. For a hearing device in accordance with FIG. 2 accommodated in front of the entry of the outer auditory canal 11 by means of the holder 8, this all-round radiation would be additionally reflected and scattered, which is indicated by the different proportions 6′ of wave trains. Feedback via the microphone and thereby disturbance to the hearing device used and to the environment would thus be produced right from the start. In addition only a part of the sound issued by the hearing module would reach the ear, whereas with a hearing device 1 or hearing module practically the entire emitted sound output reaches the ear. The loss of sound output for a hearing device 1 or hearing module not located in the auditory canal could on the other hand be compensated for by a greater amplification, in which case the additional power to be drawn from the electrical batteries for this purpose would appear to be tolerable.

As a result of the increased sound output produced by hearing device 1 the susceptibility to undesired feedback effects would even be increased. In addition even if the feedback can be kept so low that the onset of undamped oscillations would be avoided, acoustic signals would be emitted to the environment which are not intended for it. The question as to whether these signals would be perceived as disruptive by a person in the vicinity of the hearing device wearer or even perceived at all is not an easy one to answer. The sound output emitted in the vicinity of hearing device 1 would certainly be kept small to avoid undesired feedback right from the start, and with increasing distance from the hearing device would decrease rapidly because the decrease is more than proportional. On the other hand the signals contained in the sound output correspond to those from which they are derived; it is only that they have passed through the system of the hearing device 1 and have been changed according to its characteristic.

The object of the invention is therefore to embody a hearing device such that it compensates as specified for hearing deficiencies for its wearer, but on the other hand does not have to be inserted into the auditory canal and despite this is not susceptible to feedback and does not disturb persons in the vicinity of the hearing aid wearer through acoustic signals not intended for them.

This object is achieved according to the invention by the features of the claims. Further developments and embodiments emerge from the subclaims. The invention is explained in greater detail in the exemplary embodiments described in FIG. 3 to 6.

The idea underlying the invention is that of using the physical-acoustic phenomenon of what is known as Tartini tones, as described by Georg Andreas Sorge, 1703 to 1778, (Literature: Wilhelm H. Westphal, physics textbook, paragraph 90 “oscillations, combination tones”, Springer-Verlag 1953).

In experiments with two tones, that is with two sinusoidal oscillations of which the frequencies lie close to each other with a frequency difference of up to 20 Hz, the tones coalesce into one tone with audible fluctuations. With a larger frequency difference a dissonance is heard. The phenomenon of the Tartini tones now lies in the fact that a difference tone can be heard, i.e. a tone with the difference of the frequencies of the two tones, although such a tone is objectively not contained in the sound field. According to the textbook cited the tone only arises in the eardrum of the ear: The eardrum does not present the same elastic resistance against inwards and outwards deflections and therefore its oscillations do not precisely match the equation (24).” (end of quote). The equation (24) expresses the signal produced by the overlaying of two sinusoidal oscillations with different frequencies f₁ and f₂ through one sinusoidal oscillation of half the sum frequency, of which the amplitude changes according to a cosine oscillation of half the difference frequency. This situation will be further described by the direct continuation of the quote (in the quote the frequencies are labeled with the letter f instead of with v as in the text book): “for this reason a wave with the frequencies f₁ and f₂ excites in it not only an oscillation with these frequencies but also oscillations of the frequencies m·f₁+n·f₂ or a m·f₁−n·f₂ (m, n whole numbers). The tones generated in this way are generally referred to as combination tones, especially summation and difference tones (Sorge 1744, incorrectly also called Tartini tones). The greatest difference which occurs is f₁-f₂ (end of quote). This also describes a non-liner transmission process of a system in the sense of system theory of communication technology which represents the transmission path from the entry of the outer ear via the middle ear through to the inner ear, in which in the so-called organ of Corti the sense of hair cells convert the acoustic signal into a nerve signal, i.e. an electrical signal.

Here is a further quote from Wikipedia, the free encyclopedia, about the formation of the difference tone (found at “http://DE.wikipedia.org/wiki/difference” on 29.03.06): “This effect is utilized by musicians in tuning instruments, in which the tone generators (e.g. strings, pipes) are to be tuned at an interval of a pure fifth. The difference tone sounds precisely one octave below the lower tone generator.” (end of quote). The fifth above a basic tone of the frequency f is higher than the frequency by a factor of 1.5, i.e. 1.5·f. Thus a difference tone is formed with the frequency 0.5·f, with the difference tone thus laying an octave below the basic tone.

Without commenting further on the described phenomenon of Tartini tones it should be pointed out in addition that with the overall transmission system from the entry of the outer ear or through to the sense cells in the organ of Corti a chain or cascade circuit of subsystems is involved in which not just the subsystem formed by the eardrum must exhibit non-linear transmission characteristics.

Other subsystems can also be involved in the non-linear behavior of the overall transmission system, meaning the mechanics of sound transfer by the hearing bone chain (hammer, anvil, stirrup) in the middle ear or sound-conducting or signal transformation processes in the inner ear. It will merely be pointed out here that the transmission process is a non-linear process with the above described consequence of perception of a difference tone of frequency f₁−f₂, if two tones with the frequencies f₁ and f₂ are fed to the ear in addition to the perception of these two tones themselves.

The idea underlying the invention will now be developed as follows: Let the task of the inventive hearing device 1 according to FIG. 2 placed in front of the entry of the auditory canal 11 be to communicate a tone applied from outside of frequency [symbol] to the ear without the problem discussed at length above of feedback and a disturbance to the environment. This is successful if such a target tone of frequency [symbol] is combined on an electronic path with a tone of the frequency f_{T} (T stands for carrier frequency) into a summation tone of frequency [symbol] [symbol] , in which case f_{T} should lie sufficiently far, but not too far above the frequency range perceptible to human hearing. If this tone of the frequency is fed with a tone of the frequency f_{T} to the ear, the tone of the frequency [symbol] as a difference between these two tones with the frequencies [symbol] + [symbol] and f_{T}, because of the described non-linear behavior of the transmission system produced through the ear, is able to be perceived by the hearing. If in this case the non-audible tone with the frequency f_{T} remains constant in its amplitude and if the amplitude of the likewise non-audible summation tone with the frequency [symbol] + [symbol] varies in proportion to the amplitude of the target tone with the frequency f₀, then the desired result is achieved.

The creation of the two tones to be fed the ear with the frequencies [symbol] + [symbol] and f_{T} is described in FIG. 3. The microphone 3′ responds to all tones occurring in the sound field and converts these into an electrical signal which is fed for pre-processing by filtering and amplification to the subsystem 12. Here the tone and the frequency f₀ is filtered out from the frequency spectrum of the offered signal of and if necessary or expedient in the interests of the given requirement for hearing impediment, correction its amplitude is changed with the tone of the frequency f₀ representing a frequency spectrum of tones. The tone of frequency f₀ is fed, as is the oscillation of the frequency [symbol] generated in the oscillation generator or oscillator 13, to the modulator or mixer 15, in which the summation tone of frequency f_{T}+f₀ is created. Where the mixing produces other combination tones as well, these are held back by means of the filter 16, whereas the summation tone of frequency f_{T}+ [symbol] and also the tone of frequency f_{T} can pass the frequency filter 16 the way to the adder 18, to which adder 18 the harmonic of the frequency f_{T} created in the oscillation generator 13 and constant in its amplitude is also fed. Subsystems 14 and 17 are used for any necessary or expedient adaptation of amplitude and phase angle of the oscillation of frequency f_{T} before its entry into the mixer 15 or the adder 18.

Thus the two oscillations of the frequencies f_{T}+f₀ and f_{T} reach the earpiece 4′ via the subsystem 19 as electrical signals, which it converts into acoustic signals which for their part are fed to the ear. Here, with sufficient strength of the incoming sound wave with the two oscillations of frequencies f_{T}+f₀ and f_{T}, the difference tone of frequency f₀ is formed as intended. As already stated in the previous observation, the frequency f₀ is representative of a frequency band or a frequency spectrum (in the range of the audible frequencies). The subsystem 19 is used for possible adaptation of the signals in amplitude and phase angle to the earpiece 4′, also as a function of the frequency where necessary.

If for technical reasons one wished place the frequency filter 16 behind the adder 18 instead of in front of this unit, the filter 16 would in any event also have to let the oscillation of the frequency f_{T} pass through.

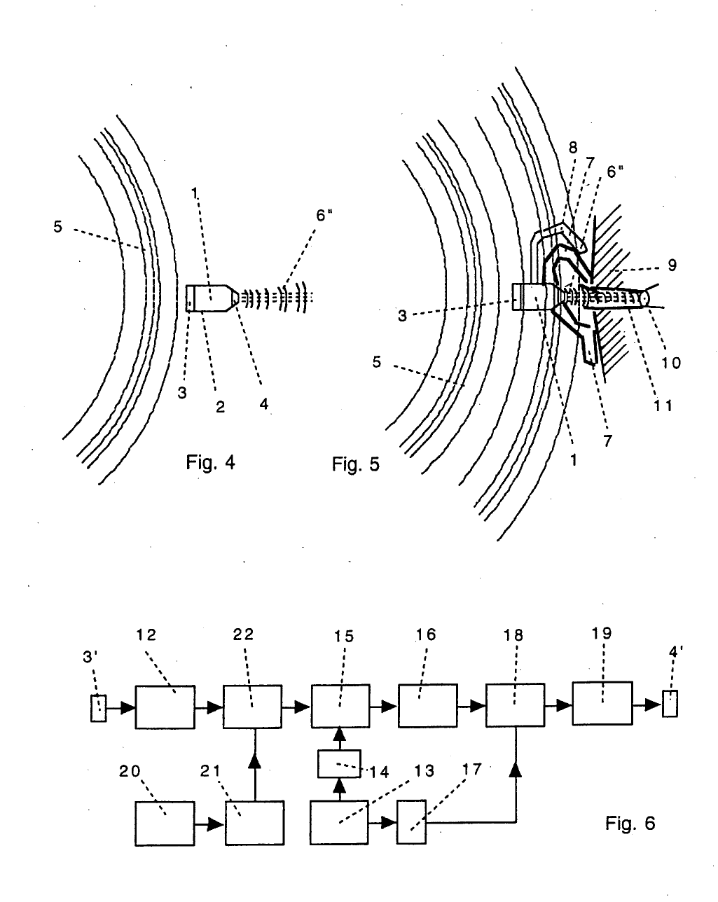

The signal fed into the ear is now characterized by the fact that it now only contains tones of which the frequencies lie above the audible frequency range. If for example the frequency f_{T} was selected as 20 kHz, the acoustic wave occurring behind the earpiece 4′ in accordance with the equation λ·f=v (wavelength times frequency equals propagation speed the wave) has a wavelength of around 1.5 cm. This means that the wavelength lies in an order of magnitude of the small dimensions which are also to be assigned to the earpiece 4′ of a hearing device 1. This means that the intensity of the sound waves radiated by the oscillator can be influenced in a directional manner by the shape of the surface radiating the sound of the electro-acoustic oscillator of the earpiece 4′ and/or through a division of this surface into sectors which undergo different, e.g. phase-offset activations, as in accordance with FIG. 4 the acoustic oscillations 6 created by the earpiece 4′ of the hearing device 1 are preferably radiated in one direction which clarifies a situation compared to that shown in FIG. 1 and can already be achieved in the simple case of a flat oscillator surface of the earpiece 4′.

The situation produced in FIG. 4 is transferred to FIG. 2, which results in FIG. 5.

The arrangement shown here thus on the one hand allows a part of the sound field applied to the ear from the outside to reach the ear directly. On the other hand tones of specific frequencies are selected in the hearing device 1, in the example f₀, amplified and converted into the frequency in order to be able then to be transferred to the ear and for this to be done so that in the ear the tones of the selected frequencies, in the example f₀, are perceived as amplified. This process corresponds to a visual aid which, through its design, allows both direct vision and vision with corrections; in the simplest case this is reading glasses with narrow lenses over the edge of which one can look.

If despite the outgoing radiation of the sound waves directed from earpiece 4′, a part thereof can still reach the microphone 3′ through reflection and scattering, this can therefore not lead to feedback since in a subsystem 12 connected downstream from the microphone 3′ basically only frequencies f₀ within the range of audible frequencies are amplified and processed and it therefore blocks off the frequencies. To make this blocking particularly effective a bandpass for lowpass filter can also be connected upstream from a subsystem 12 which only allows signals with frequencies in the audible frequency range to enter the subsequent part of the system chain.

Disturbances in the vicinity of the hearing device wearer caused by a proportion of the signals directed to the hearing device wearer, which the ear of another person can basically precisely convert into hearing sensations in the same way as the hearing aid wearer themselves, are thus less likely if the intended sound output for the hearing aid wearer is directed to his ear as a more or less directed bundle in accordance with FIG. 4 and 5 and the sound output discharged into the surroundings is already reduced in this way. For a person in the vicinity of the hearing aid wearer the necessary sound output for the tones of the oscillations of frequencies f_{T}+f₀ and f_{T} might rarely be reached in order to cause an oscillation of frequency f₀ of a perceptible size to be produced in the ear of this person through these non-linear transmission characteristics. And a feedback which magnifies this undesired effect is not present, as already established.

The previous basic observation would also be attributable to the individual differences of the non-linear transmission behavior of the ears belonging to different persons. Thus it is to be assumed that by changing the amplitudes and if necessary also the phases of the oscillations fed into the ear of frequencies f_{T}+f₀ and f_{T} the desired effect of conversion into an oscillation of frequency f₀ can be set to an optimum. For this purpose the subsystems as depicted in the block diagram shown in FIG. 4 can be included, which as already stated above, are provided for adaptation of amplitude and phase of the oscillation of the frequency f_{T} fed by the oscillator on one side to the mixer 15 and on the other side to adder 18.

Another contribution to an optimization effect could also be to feed to the ear not only oscillations of frequencies f_{T}+f₀ and f_{T}, but also the oscillation of frequency f_{T}−f₀ derived from the same mixing process, with all three given oscillations then being combined into one spectrum which represents a carrier oscillation of frequency f_{T} amplitude-modulated in a classical manner with frequency f0. However because of the lower frequency f_{T}−f₀, depending on the necessary selection of the carrier frequency f_{T} this could result in frequency band conflicts, since the oscillations fed to the ear should remain above the frequency range which however can still be seen as individual.

Thus the use of the described arrangement could go beyond compensating for hearing weaknesses in the sense of obtaining improved information from a disturbed acoustic signal. The arrangement could for example be designed so that from a wideband noise signal with disturbance noise components a band to be preferred in the audible frequency range is fed to the ear by means of the hearing device 1 first with noise removed and then amplified, without blocking access by the original sound field to the ear.

Another form of use would be to compensate for specific tinnitus problems in the form of tones of a constant tone level and strength, i.e. of periodic oscillations of constant amplitude and frequency fₛₜ (fₛₜ for fault). It appears possible to ameliorate or also to remedy such tinnitus by an oscillation of the same frequency fₛₜ but of an opposing phase angle fed to the ear from outside by selection of a suitable amplitude, provided that the cause of the fault is to be found in the transmission system represented by the ear itself.

To this end, in the arrangement described in FIG. 3, in accordance with FIG. 6 an oscillator or oscillation generator 20 is included, with which, by selecting the oscillation of frequency fₛₜ which simulates the tinnitus problem, this oscillation of frequency fₛₜ is fed via a subsystem 21 for setting amplitude and phase to an adder 22 to which the above-described oscillations of frequency f₀ of the audible range are also fed. Both oscillations with frequencies fₛₜ and f₀ are now subject to the same frequency conversion by the mixer 15 and in this converted form are finally fed to the earpiece 4′ for conversion into sound. Amplitudes and phase angle of this oscillation fₛₜ are then set with subsystem 21 so that a minimum is produced for the tinnitus noise or this noise disappears. Sound signals applied to the microphone from the outside with the frequency of the tinnitus tone are to be viewed as non-synchronous to the tinnitus oscillation, which enables them to be perceived with a compensated tinnitus signal.

Like the oscillation of frequency f₀ which can stand for a spectrum of oscillations or for a frequency band, the oscillation of frequency fₛₜ can basically stand for a number of oscillations with different frequencies, for which a number of oscillations must then be created in the system to compensate for the tinnitus signal, by multiple implementation of the oscillation generator 20 with associated subsystem 21 for setting amplitude and phase.

For sounds in the ear which vary over time in their type and intensity, which can thus not be represented by a number of sinusoidal oscillations of constant frequency and amplitude, the ear is frequently provided with “informationless noise” for masking the tinnitus noise, or also with background music. The method described here and by means of FIG. 5 can also be used for this purpose, by the combination with a hearing correction of the frequency ranges involved with ongoing non-blocked access for sound waves directed to the ear from the outside. Thus a use would be conceivable without hearing correction so that persons in the vicinity of the system user will not be disturbed by the masking noise.

If it were merely a matter of creating an oscillation to compensate for a tinnitus oscillation or creating an ongoing noise to mask out the tinnitus, i.e. by excluding the picking up and amplification of sound signals, these signals do not necessarily have to be created in the audible frequency range and then converted by means of the carrier frequency f_{T} and of a mixer 15 into the frequency range above the carrier frequencies.

Here the use of two oscillators would be conceivable, both operating from the outset in the range of the higher frequencies considered, and of which one creates an oscillation of the carrier frequency f_{T} and the other creates an oscillation of a frequency of which the difference to the carrier frequency f_{T} corresponds to the frequency of the tinnitus sound to be compensated for. The sinusoidal oscillation created by the second oscillator would be able to be adjusted for amplitude and phase either at the oscillator itself or in a downstream subsystem to be provided for it.

If, instead of a sinusoidal oscillation a spectrum of composite signals is to occur, e.g. for the creation of noises, the second oscillator could also take over this task, if necessary in combination with a modulator.

1.-6. (canceled)

7. A hearing device to be worn in front of an auditory canal of a hearing device wearer without contacting a skin of an inner wall of the auditory canal, comprising:
a microphone that receives an audible input sound signal;
a processor that processes the audible input sound signal;
an oscillator that generates a carrier oscillation having a non-audible frequency;
a mixer that transposes a frequency spectrum of the processed input sound signal according to the carrier oscillation, the transposed frequency spectrum of the processed input sound signal having a further non-audible frequency; and
a sound emitter that emits an output sound signal comprising the transposed frequency spectrum of the processed input sound signal and the carrier oscillation in the auditory canal.

8. The hearing device as claimed in claim 7, wherein the mixer transposes the frequency spectrum of the processed input sound signal by adding the frequency spectrum of the processed input sound signal with the non-audible frequency of the carrier oscillation.

9. The hearing device as claimed in claim 7, wherein the output sound signal is transposed back into an audible frequency to the hearing device wearer through a non-linear transmission characteristic of an ear of the hearing device wearer.

10. The hearing device as claimed in claim 7, wherein a portion of the output sound signal feeds back to the microphone as a feedback signal having the further non-audible frequency that is different with the audible input sound signal.

11. The hearing device as claimed in claim 10, wherein the feedback signal is not processed by the processor and thus not fed to the sound emitter so that a feedback effect is avoided.

12. The hearing device as claimed in claim 10, further comprising a filter connected upstream of the processor that filters out the non-audible feedback signal.

13. The hearing device as claimed in claim 7, wherein a dimension of the sound emitter is in an order of a magnitude of an acoustic wavelength of the output sound signal so that an energy of the output sound signal is bundled.

14. The hearing device as claimed in claim 13, wherein the energy of the output sound signal is bundled based on a surface shape of the sound emitter.

15. The hearing device as claimed in claim 7, wherein a sinusoidal oscillation or a tone having a same frequency with a tinnitus is generated to remedy the tinnitus by overlaying the tinnitus with the sinusoidal oscillation or the tone in an opposite phase angle.

16. The hearing device as claimed in claim 15, wherein the sinusoidal oscillation or the tone is generated in a variable frequency oscillation generator and is transposed by the mixer and emitted by the sound emitter in the auditory canal.

17. The hearing device as claimed in claim 16, wherein the hearing device improves a hearing ability of the hearing device wearer by compensating the tinnitus.

18. The hearing device as claimed in claim 15, wherein a noise is generated in a noise generator and is used to mask out the tinnitus.

19. A method for operating a hearing device to be worn in front of an auditory canal of a hearing device wearer without contacting a skin of an inner wall of the auditory canal, comprising:
receiving an audible input sound signal by a microphone of the hearing device;
processing the audible input sound signal;
generating a carrier oscillation having a non-audible frequency;
transposing a frequency spectrum of the processed input sound signal according to the carrier oscillation, the transposed frequency spectrum of the processed input sound signal having a further non-audible frequency;
emitting an output sound signal comprising the transposed frequency spectrum of the processed input sound signal and the carrier oscillation in the auditory canal; and
transposing the output sound signal back into an audible frequency to the hearing device wearer through a non-linear transmission characteristic of an ear of the hearing device wearer.

20. The method as claimed in the claim 19, wherein the frequency spectrum of the processed input sound signal is transposed by adding the frequency spectrum of the processed input sound signal with the non-audible frequency of the carrier oscillation

21. The method as claimed in the claim 19, wherein a portion of the output sound signal feeds back to the microphone as a feedback signal having the further non-audible frequency that is different with the audible input sound signal.

22. The method as claimed in the claim 21, wherein the feedback signal is not processed so that a feedback effect is avoided.

23. The method as claimed in the claim 21, further comprising filtering out the non-audible feedback signal before processing.

24. The method as claimed in the claim 19, wherein a sinusoidal oscillation or a tone having a same frequency with a tinnitus is generated to remedy the tinnitus by overlaying the tinnitus with the sinusoidal oscillation or the tone in an opposite phase angle.

25. The method as claimed in the claim 24, wherein the sinusoidal oscillation or the tone is generated in a variable frequency oscillation generator and is transposed and emitted in the auditory canal.

26. The method as claimed in the claim 25, wherein the hearing device improves a hearing ability of the hearing device wearer by compensating the tinnitus.
